(19) United States
(12) Patent Application Publication
(10) Pub. No.: US 2016/0062857 A1
(43) Pub. Date: Mar. 3, 2016

(54) FAULT RECOVERY ROUTINE GENERATING DEVICE, FAULT RECOVERY ROUTINE GENERATING METHOD, AND RECORDING MEDIUM

(71) Applicant: NEC CORPORATION, Tokyo (JP)

(72) Inventor: KUMIKO TADANO, Tokyo (JP)

(21) Appl. No.: 14/779,389

(22) PCT Filed: Jan. 23, 2014
(86) PCT No.: PCT/JP2014/000331

§ 371 Date: Sep. 23, 2015

(30) Foreign Application Priority Data
Apr. 17, 2013 (JP) 2013-086208

(51) Int. Cl. G06F 11/20

(52) U.S. Cl. CPC G06F 11/2033; G06F 2201/805

(57) ABSTRACT

A fault recovery routine generating device includes a subroutine storage unit which stores subroutines, a precondition storage unit which sores a precondition, a fault combination acceptance unit which accepts a combination of faults that have occurred in components of an information system, a subroutine specification unit which identifies subroutines required for recovery of the components, a fault recovery routine generating unit which acquires the identified subroutines from the subroutine storage unit and links the subroutines to generate a candidate fault recovery routine which is a routine for recovering the information system, a fault recovery time estimation unit which estimates the time required for fault recovery by the candidate fault recovery routine, and a fault recovery routine output unit which outputs the candidate fault recovery routine whose fault recovery time is less than or equal to predetermined time as a fault recovery routine.

### TECHNICAL FIELD

The present invention relates to a fault recovery routine generating device, a fault recovery routine generating method and a fault recovery routine generating program that generate a recovery routine for an information system in which a fault has occurred.

### BACKGROUND ART

If a large-scale disaster occurs, many of the components of an information system can fail concurrently. For recovering an information system in the event of such a large-scale disaster, an operation routine (a fault recovery routine) designed to recover the entire information system in which concurrent component faults (component failure) have occurred is required. The term component as used in the following description sometimes refers to a group of a plurality of components. The term subroutine as used in the following description sometimes refers to a group of a plurality of subroutines.

A fault recovery routine for an information system includes subroutines (such as command inputs and graphical user interface operations, for example) for recovering from component faults that have occurred. Since different component faults require different subroutines, fault recovery routines required vary depending on a combination of component faults. Because there are a huge number of combinations of faults of many components that can occur concurrently, it is impractical for a user to manually generate fault recovery routine for all possible combinations. It is rational to automatically generate fault recovery routines.

NPL 1 describes a method for automatically generating counter procedure to be performed in an abnormal situation of a plant. The method described in NPL 1 enables automatic generation of a counter procedure to be executed in an abnormal situation of a plant by setting items of information such as a performance objective and the current state of the plant.

### CITATION LIST

### Non Patent Literature

[NPL 1] Daisuke Abe and Akio Gofuku, “Study on a Systematic Generation Technique of Counter Operation Procedure in an Abnormal Situation of a Plant”, Transactions of the Japan Society of Mechanical Engineers, No. 105-1, pp. 235-236.

### SUMMARY OF INVENTION

### Technical Problem

One of typical customer requirements specified for fault recovery of an information system is an indicator called RTO (Recovery Time Objective), which represents the time required for recovery. If the RTO is not met, the provider of the information system may have to pay a penalty cost to customers. The provider of the information system therefore needs to generate a fault recovery routine so that the RTO is met.

The technique described in NPL 1 has a problem that it is difficult to automatically generate a fault recovery routine that meets an RTO when there are complicated preconditions for executing subroutines such as fault recovery routines for an information system.

An example of complicated precondition may be that a particular component is in a particular state. Specifically, preconditions may be that a database has been activated, a device has been mounted, a backup file is available, an operating system has been installed, and an application has been configured.

Another example of complicated precondition may be that a particular subroutine has been executed beforehand. For example, the operating system on which an application runs needs to be activated before the application can be activated. Another example of complicated precondition may be that a particular subroutine is not being executed, for example backup is being executed. For the reason described above, it is difficult to apply the technique described in NPL 1 to fault recovery of an information system.

The present invention has been made in light of the problem described above and an object of the present invention is to provide a fault recovery routine generating device, a fault recovery routine generating method and a fault recovery routine generating program that can automatically generate a fault recovery routine that meets an RTO by using subroutines with preconditions in accordance with a combination of component faults that have occurred.

### Solution to Problem

A fault recovery routine generating device relating to this invention comprises:

a subroutine storage unit which stores subroutines which are routines for recovering failed components;

a precondition storage unit which stores a precondition representing a condition required for executing the subroutines;

a fault combination acceptance unit which accepts a combination of faults that have occurred in components of an information system;

a subroutine specification unit which identifies subroutines required for recovering the components on the basis of the precondition and the combination of faults that have occurred in the components;

a fault recovery routine generating unit which acquires the identified subroutines from the subroutine storage unit and links the identified subroutines to generate a candidate fault recovery routine which is a routine for recovering the information system;

a fault recovery time estimation unit which estimates the time required for fault recovery by the candidate fault recovery routine; and

a fault recovery routine output unit which outputs the candidate fault recovery routine whose fault recovery time is less than or equal to predetermined time as a fault recovery routine.

A fault recovery routine generating method relating to this invention comprises:

storing subroutines which are routines for recovering components;

storing a precondition representing a condition required for executing the subroutines;

accepting a combination of faults that have occurred in components of an information system;

identifying subroutines required for recovering the components on the basis of the precondition and the combination of faults that have occurred in the components;

acquiring the identified subroutines from among the stored subroutines and linking the identified subroutines to generate a candidate fault recovery routine which is a routine for recovering the information system;

estimating the time required for fault recovery by the candidate fault recovery routine; and

outputting the candidate fault recovery routine whose fault recovery time is less than or equal to predetermined time as a fault recovery routine.

A fault recovery routine generating program relating to this invention causing a computer to execute:

a subroutine storage step of storing subroutines which are routines for recovering components;

a precondition storage step of storing a precondition representing a condition required for executing the subroutines;

a fault combination acceptance step of accepting a combination of faults that have occurred in components of an information system;

a subroutine specification step of identifying subroutines required for recovering the components on the basis of the precondition and the combination of faults that have occurred in the components;

a fault recovery routine generating step of acquiring the identified subroutines from among the stored subroutines and linking the identified subroutines to generate a candidate fault recovery routine which is a routine for recovering the information system;

a fault recovery time estimation step of estimating the time required for fault recovery by the candidate fault recovery routine; and

a fault recovery routine output step of outputting the candidate fault recovery routine whose fault recovery time is less than or equal to predetermined time as a fault recovery routine.

### Advantageous Effects of Invention

According to the present invention, a fault recovery routine that meets an RTO can be automatically generated from subroutines with preconditions in accordance with a combination of component faults that have occurred.

### BRIEF DESCRIPTION OF DRAWINGS

FIG. 1 is a block diagram illustrating a configuration of a first exemplary embodiment of a fault recovery routine generating device according to the present invention.

FIG. 2 is a block diagram illustrating a configuration of a subroutine specification unit.

FIG. 3 is a diagram illustrating exemplary preconditions stored in a precondition storage unit according to the first exemplary embodiment.

FIG. 4 is an activity diagram illustrating exemplary subroutines.

FIG. 5 is a flowchart illustrating an operation of the first exemplary embodiment of the fault recovery routine generating device according to the present invention.

FIG. 6 is a block diagram illustrating a configuration of a second exemplary embodiment of a fault recovery routine generating device according to the present invention.

FIG. 7 is a diagram illustrating exemplary preconditions stored in a precondition storage unit according to the second exemplary embodiment.

FIG. 8 is a flowchart illustrating an operation of the second exemplary embodiment of the fault recovery routine generating device according to the present invention.

FIG. 9 is a block diagram illustrating a configuration of a third exemplary embodiment of a fault recovery routine generating device according to the present invention.

FIG. 10 is a flowchart illustrating an operation of the third exemplary embodiment of the fault recovery routine generating device according to the present invention.

### DESCRIPTION OF EMBODIMENTS

Exemplary embodiments of fault recovery routine generating devices according to the present invention will be described below with reference to drawings.

A fault recovery routine will be described first. A fault recovery routine is a routine for recovering an information system by recovering a group of failed components in the information system. The fault recovery routine includes subroutines, each of which is a routine for recovering each of components included in the information system. Each subroutine includes system management operations such as replace, reboot, data recovery, and reconfiguration. The subroutines are described in a document or a manual beforehand for components to be recovered.

If components fail concurrently due to a disaster, a system operator (hereinafter referred to as operator) is responsible for recovering the components in accordance with a fault recovery routine. Subroutines required vary depending on the combination of failed components. The operator therefore first accurately locates damages to the system (i.e. identifies failed components), then executes subroutines to be executed for system recovery. Faulty states of components of the system include not only component down states but also states in which the components are not available in a normal manner, such as a state in which some of essential commands cannot be executed and a state in which some of data required for the system have been lost. Subroutines included in a fault recovery routine vary depending on these different types of faulty states.

### Exemplary Embodiment 1

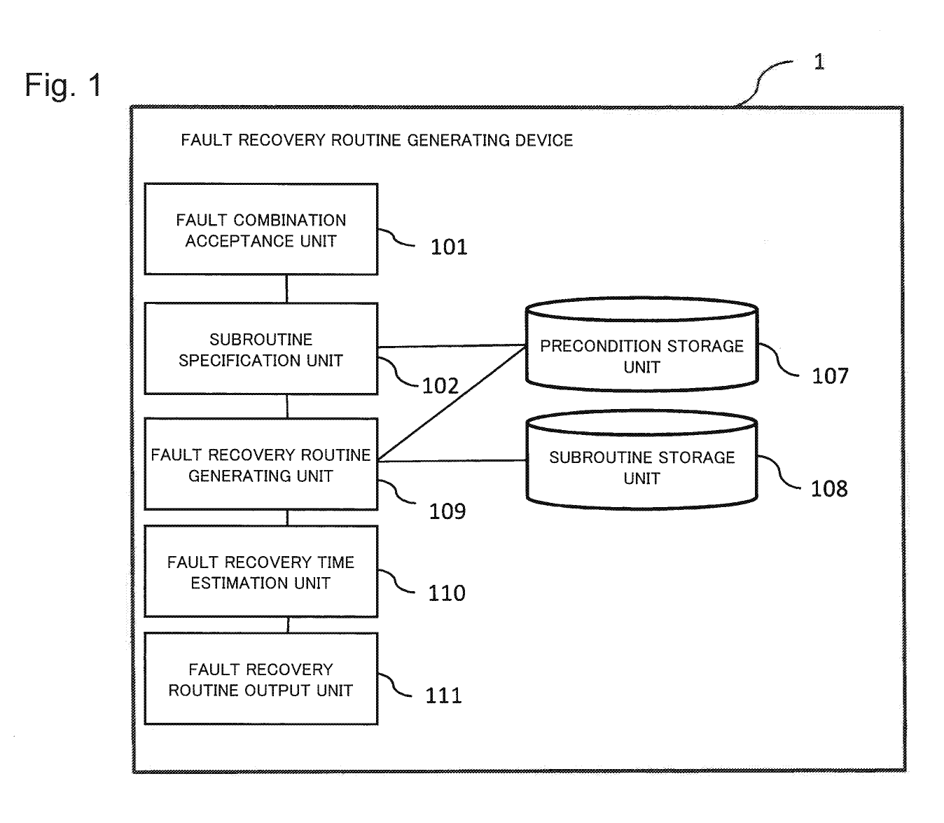

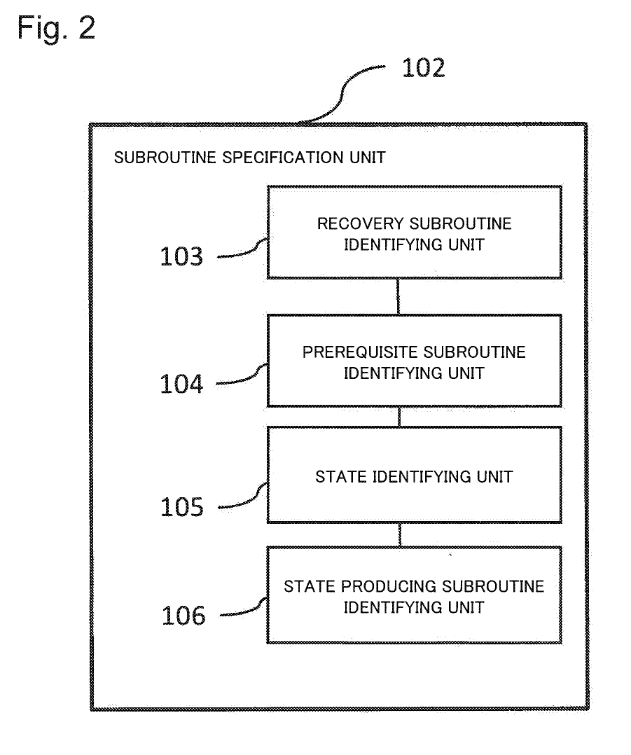

FIG. 1 is a block diagram illustrating a configuration of a fault recovery routine generating device 1 according to a first exemplary embodiment (exemplary embodiment 1). FIG. 2 is a block diagram illustrating a configuration of a subroutine specification unit 102. The fault recovery routine generating device 1 according to this exemplary embodiment is implemented by a typical information processing device (computer). The fault recovery routine generating device 1 may be a server device, a personal computer or the like, for example.

The fault recovery routine generating device 1 includes a central processing unit (CPU), storage devices (a memory and a hard disk drive (HDD)), an input device (for example a keyboard) and an output device (for example a display), which are not depicted. The fault recovery routine generating device 1 is configured to implement functions, which will be described later, by the CPU executing a program stored in a storage device.

The fault recovery routine generating device 1 includes a fault combination acceptance unit 101, a subroutine specification unit 102, a precondition storage unit 107, a subroutine storage unit 108, a fault recovery routine generating unit 109, a fault recovery time estimation unit 110, and a fault recovery routine output unit 111.

The fault combination acceptance unit 101 accepts a combination of faults that have occurred in components of an information system. A combination of component faults may be specified by the names of components, like {“application A”, “database B”} or may be specified by numbers preassigned to components, like {1, 2, 3}.

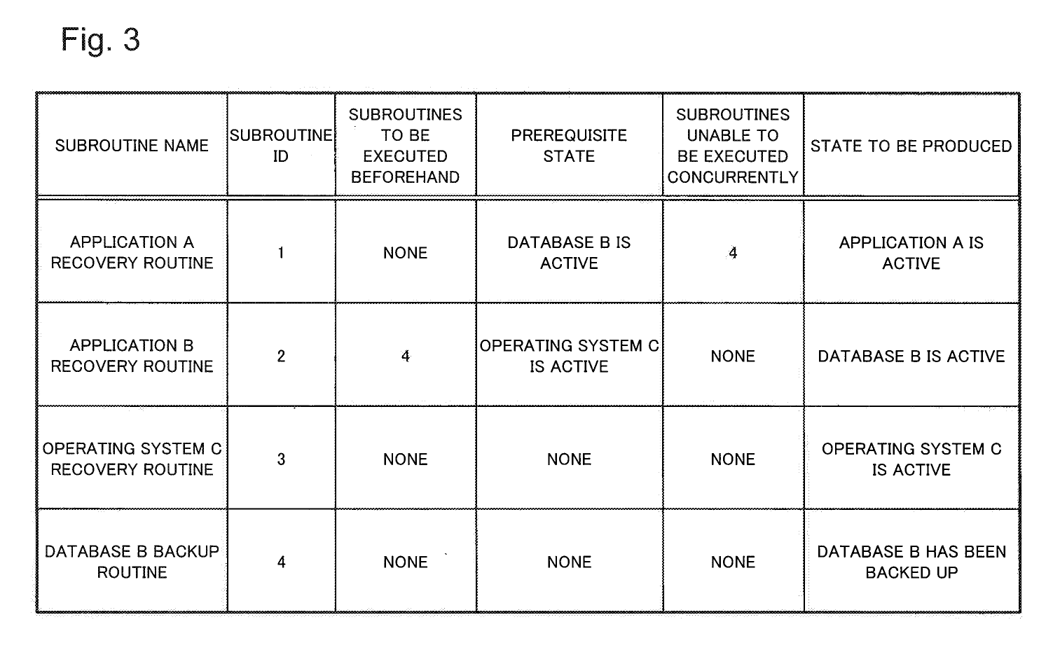

The precondition storage unit 107 stores preconditions representing conditions required when subroutines are performed. FIG. 3 is a diagram illustrating exemplary preconditions stored in the precondition storage unit 107. As illustrated in FIG. 3, a precondition in this exemplary embodiment includes a subroutine ID, subroutines to be executed beforehand, a prerequisite state, subroutines that cannot be executed concurrently, and a state to be produced. A precondition may further include a subroutine name for allowing the user to readily identify the precondition.

The subroutine ID is an ID identifying a subroutine. A subroutine to be executed beforehand is a subroutine that needs to be executed before the subroutine can be executed. A prerequisite state is a state in which a component needs to be before the subroutine is executed. Subroutines that cannot be executed concurrently are subroutines that cannot be executed concurrently with the subroutine. A state to be produced is a state of a component that is produced when the subroutine is executed.

The subroutine specification unit 102 identifies all subroutines that are required for recovery on the basis of a precondition stored in the precondition storage unit 107 and a combination of faults accepted by the fault combination acceptance unit 101. As illustrated in FIG. 2, the subroutine specification unit 102 includes a recovery subroutine identifying unit 103, a prerequisite subroutine identifying unit 104, a state identifying unit 105, and a state producing subroutine identifying unit 106.

The recovery subroutine identifying unit 103 identifies subroutines for recovering failed components with reference to information stored in the precondition storage unit 107 on the basis of a combination of faults accepted by the fault combination acceptance unit 101.

The prerequisite subroutine identifying unit 104 identifies a subroutine (prerequisite subroutine) that needs to be executed before an identified subroutine is executed with reference to the “subroutine to be executed beforehand” stored in the precondition storage unit 107.

The state identifying unit 105 identifies a component state required for executing all subroutines identified by the recovery subroutine identifying unit 103 and the prerequisite subroutine identifying unit 104 with reference to the “prerequisite states” stored in the precondition storage unit107.

The state producing subroutine identifying unit 106 identifies a subroutine that produces a component state (prerequisite state) identified by the state identifying unit 105 with reference to the “state to be produced” stored in the precondition storage unit 107. Specifically, the state producing subroutine identifying unit 106 searches the precondition storage unit 107 for the “state to be produced” that matches the “prerequisite state” identified by the state identifying unit 105 and identifies a subroutine that produces the “state to be produced”. For example, the “prerequisite state” of the subroutine with subroutine ID 1 is “database B is active”, which matches the “state to be produced” of the subroutine with subroutine ID 2. Accordingly, the state producing subroutine identifying unit 106 identifies “application B recovery routine” with subroutine ID 2 as the subroutine that produces “database B is active”.

In this way, the subroutine specification unit 102 identifies all subroutines that are required for recovery from the acquired combination of faults.

The subroutine storage unit 108 stores subroutines that are routines for recovering failed components. The subroutine storage unit 108 in this exemplary embodiment stores a combination of a subroutine ID and a subroutine itself, which are not depicted.

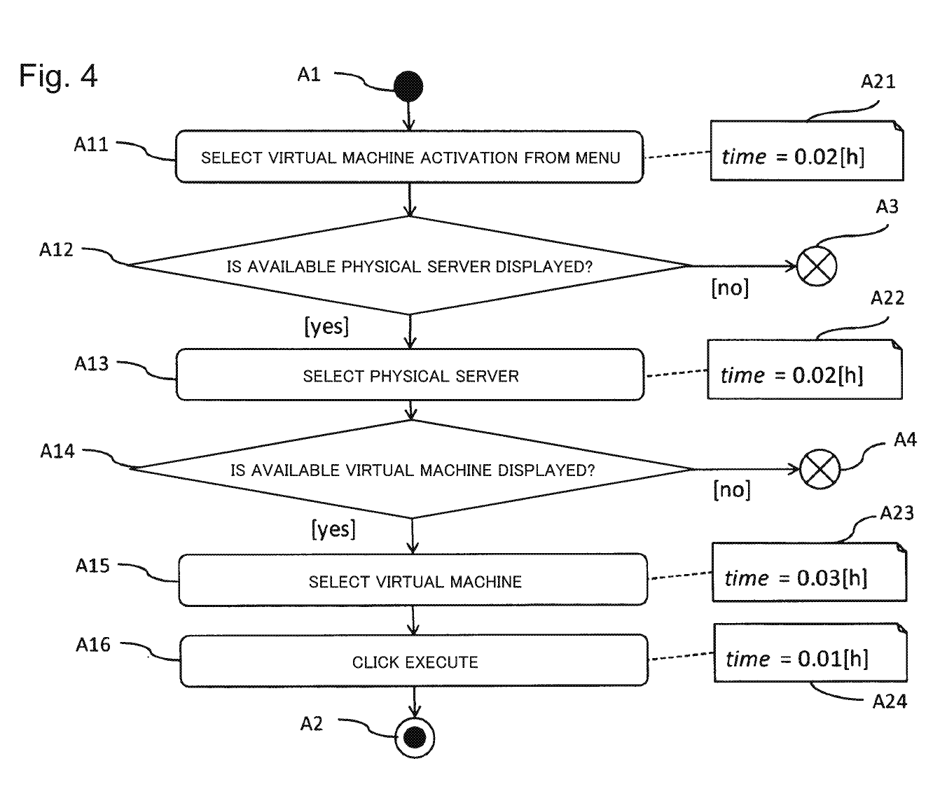

FIG. 4 is an activity diagram illustrating exemplary subroutines. In the example illustrated in FIG. 4, the subroutines are indicated in actions A11-A16 in the activity diagram. System management operations included in the subroutines are indicated in actions A11-A16 in the activity diagram. The amounts of time required for execution of the system management operations are indicated in notes A21-A24 associated with actions A11-A16. A1 indicates the start and A2, A3 and A4 indicate ends. In another exemplary method for representing subroutines, a subroutine may be represented in such a way that the time required for execution of the entire subroutine is stored along with a subroutine ID and the subroutine itself.

Processing of the subroutines illustrated in FIG. 4 will be described. First, a user selects virtual machine activation from a menu (A11). Then, if no available physical server is displayed (NO at A12), the process ends (A3). If an available physical servers is displayed (YES at A12), the user selects the physical server (A13). Then, if no available virtual machine is displayed (NO at A14), the process ends (A4). If an available virtual machine is displayed (YES at A14), the user selects the virtual machine (A15). The user then clicks Execute (A16). Note that the processing time of A11 and A13 is 0.02 [h] (A21, A22). The processing time of A15 is 0.03 [h] (A23). The processing time of A16 is 0.01 [h] (A24).

The fault recovery routine generating unit 109 retrieves all subroutines identified by the subroutine specification unit 102 from the subroutine storage unit 108 and links the subroutines together in accordance with the preconditions stored in the precondition storage unit 107 to generate a candidate fault recovery routine.

An example of a candidate fault recovery routine generating method performed by the fault recovery routine generating unit 109 will be described. First, the fault recovery routine generating unit 109 links subroutines whose execution order is constrained so that the subroutines will be executed sequentially in accordance with the constraint and links the subroutines whose execution order is not constrained so that the subroutines are executed in parallel, thereby generating a fault recovery routine. For example, if there is a subroutine that is prerequisite for execution of a given subroutine, the fault recovery routine generating unit 109 links the subroutines so that the prerequisite subroutine will be executed first. Then, if subroutines in the generated routine that are executed in parallel include operations that cannot be executed in parallel, the fault recovery routine generating unit 109 modifies the generated routine so that those subroutines will be executed sequentially.

Another example of a candidate fault recovery routine generating method performed by the fault recovery routine generating unit 109 will be described. The fault recovery routine generating unit 109 links subroutines whose execution order is constrained so that they will be executed in accordance with the constraint and then links all subroutines together so that they will be executed sequentially to generate a fault recovery routine. If there are a plurality of alternative methods of linking subroutines in accordance with execution order and parallel execution constraints, the fault recovery routine generating unit 109 uses all possible methods to generate fault recovery routines. The fault recovery routine generating unit 109 may abort the generation when a certain number of fault recovery routines have been generated, in order to reduce the amount of computation.

The fault recovery time estimation unit 110 estimates time required for executing each candidate fault recovery routine generated by the fault recovery routine generating unit 109. To estimate the required time, for example, the fault recovery time estimation unit 110 simply adds up the amounts of time required for executing the subroutines in a fault recovery routine that are to be executed sequentially and adds up the amounts of time required for executing subroutines each of which takes the greatest time in a set of subroutines to be executed in parallel. The fault recovery time estimation unit 110 may use a method that requires the smallest amount of computation to estimate the time required for execution of a fault recovery routine in which the fault recovery time estimation unit 110 simply adds up the amounts of time required for system manage operations included in each subroutine, for example. Alternatively, the fault recovery time estimation unit 110 may transform subroutines to probabilistic models such as Stochastic Petri Net models and analyze the models to estimate the time required. Alternatively, the user may calculate the amounts of time required for executing subroutines beforehand and may store the amounts of time in the subroutine storage unit 108.

The fault recovery routine output unit 111 presents only a fault recovery routine that requires time less than or equal to a predetermined RTO among the candidate fault recovery routines generated by the fault recovery routine generating unit 109 to an operator on the basis of the amounts of time output from the fault recovery time estimation unit 110. For example, the fault recovery routine output unit 111 presents the fault recovery routine on a display in the form of an activity diagram. If there are a plurality of fault recovery routines that take time less than or equal to the RTO, the fault recovery routine output unit 111 may present the plurality of fault recovery routines and allow the operator to choose one that is easy to operate, for example. Alternatively, the fault recovery routine output unit 111 may output only the fault recovery routine that requires the smallest amount of time. If there is not a fault recovery routine that takes time less than or equal to the RTO, the fault recovery routine output unit 111 may output an indication that “there is no appropriate routine” or may output a fault recovery routine that requires the smallest amount of time as reference information for the operator to make a determination.

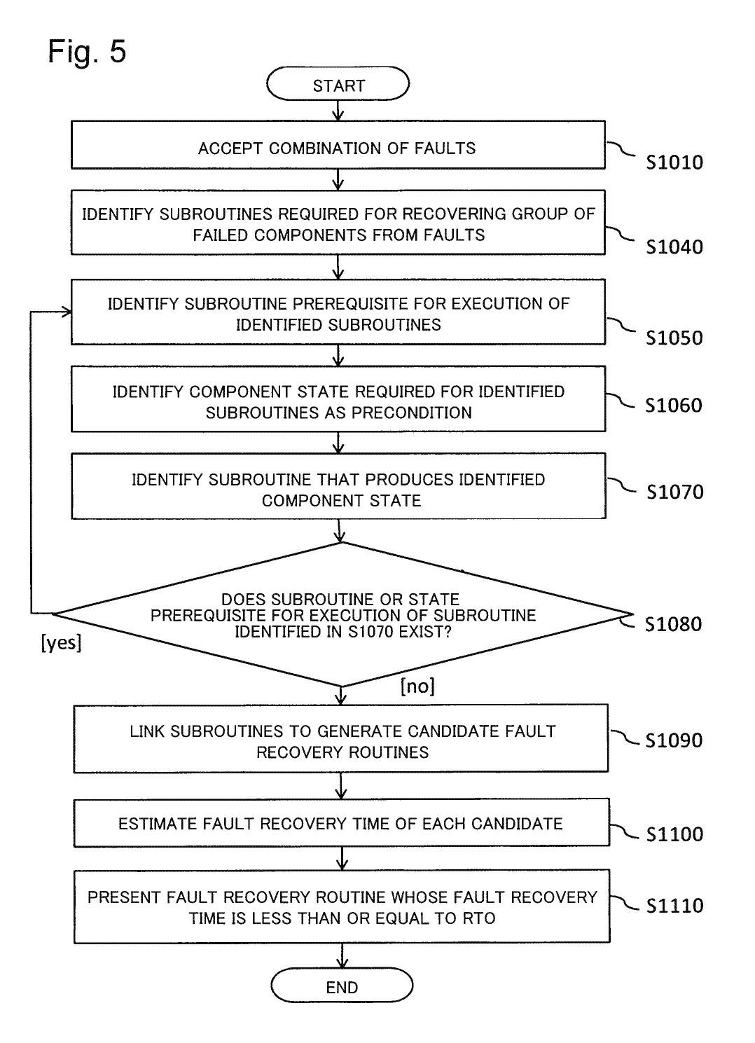

An operation of the fault recovery routine generating device 1 will be described next. FIG. 5 is a flowchart illustrating an operation of the fault recovery routine generating device according to this exemplary embodiment.

First, the fault combination acceptance unit 101 accepts a combination of faults that have occurred in components from an operator (step S1010). Then the recovery subroutine identifying unit 103 identifies a subroutine required for recovering the group of failed components from the faulty condition on the basis of the combination of faults accepted at step S1010 (step S1040).

Then the prerequisite subroutine identifying unit 104 identifies a subroutine prerequisite for execution of the subroutine identified at step S1040 (step S1050). Then the state identifying unit 105 identifies a component state required for execution of the subroutines identified at steps S1040 and S1050 (a prerequisite state) (step S1060). Then the state producing subroutine identifying unit 106 identifies a subroutine that produces the prerequisite state identified at step S1060 with reference to the precondition storage unit 107 (step S1070).

Then if there is a subroutine or a state that is prerequisite for execution of the subroutine identified at step S1070 (YES at step S1080), the processing from step S1050 through S1070 is repeated. In this case, the prerequisite subroutine identifying unit 104 identifies a subroutine that is prerequisite for execution of the subroutine identified at step S1070 (step S1050). Then the state identifying unit 105 identifies a component state (a prerequisite state) required for execution of the subroutines identified at steps S1070 and S1050 (step S1060). The state producing subroutine identifying unit 106 identifies a subroutine that produces the prerequisite state identified at step S1060 with reference to the precondition storage unit 107 (step S1070).

If there is not a subroutine or a state that is prerequisite for the subroutine identified at step S1070 (NO at step S1080), processing at step S1090 is performed.

Note that after step S1040, the state identifying unit 105 may determine a state prerequisite for the subroutine identified at step S1040 (as part of step S1060) and the state producing subroutine identifying unit 106 may determine a subroutine that produces the prerequisite state (as part of step S1070). In this case, only the processing that relates to the subroutine identified at S1050 needs to be performed at the next steps S1060 and S1070.

Then the fault recovery routine generating unit 109 links the subroutines identified at steps S1040, S1050 and S1070 in accordance with the preconditions to generate a candidate fault recovery routine (step S1090).

Then the fault recovery time estimation unit 110 estimates the time required for execution of each of the candidate fault recovery routines generated at step S1090 (step S1100). Then the fault recovery routine output unit 111 outputs a fault recovery routine whose fault recovery time estimated at step S1100 is less than or equal to the predetermined RTO on a display or the like (step S1110).

The fault recovery routine generating device 1 according to this exemplary embodiment is capable of automatically generating a fault recovery routine that meets RTO by using subroutines with preconditions in accordance with a combination of component faults that have occurred. Further, the fault recovery routine generating device 1 according to this exemplary embodiment is capable of reducing the time required for generating a fault recovery routine by automatically generating the fault recovery routine. Moreover, the fault recovery routine generating device 1 according to this exemplary embodiment is capable of reducing human errors in generating a fault recovery routine that has complicated preconditions since the fault recovery routine generating device 1 automatically generates the fault recovery routine.

### Exemplary Embodiment 2

A fault recovery routine generating device according to a second exemplary embodiment (exemplary embodiment 2) of the present invention will be described below. A user cannot predict which resources of an information system (such as the numbers of physical and virtual servers) are actually available in the event of a disaster. Therefore generating a fault recovery routine in accordance with changes in available resources is an issue. When only scarce resources are available, it is difficult to recover all of failed components and therefore recovery of a limited number of high-priority components needs to be performed.

The fault recovery routine generating device according to this exemplary embodiment differs from the fault recovery routine generating device according to the first exemplary embodiment in that the fault recovery routine generating device of this exemplary embodiment generates a fault recovery routine according to limitations of available resources on the basis of the priorities of components in the event of fault. The following description will focus on the difference from the fault recovery routine generating device according to the first exemplary embodiment.

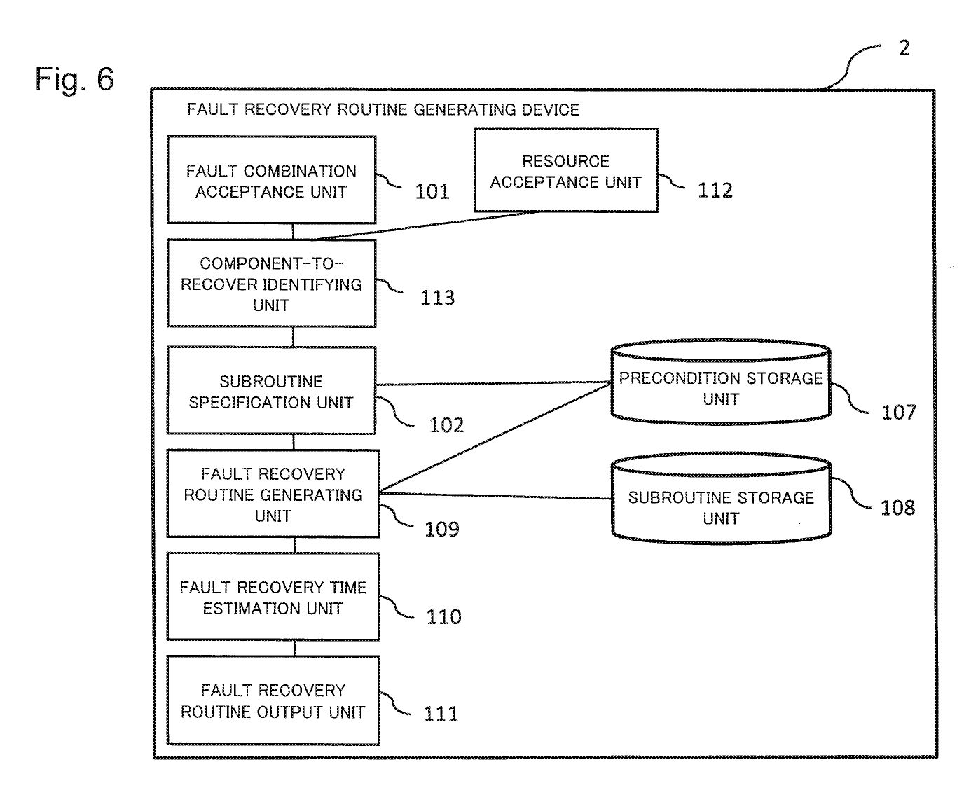

FIG. 6 is a block diagram illustrating a configuration of the fault recovery routine generating device 2 according to this exemplary embodiment. The fault recovery routine generating device 2 according to this exemplary embodiment includes a resource acceptance unit 112 and a component-to-recover identifying unit 113 in addition to the components of the fault recovery routine generating device 1 according to the first exemplar exemplary embodiment.

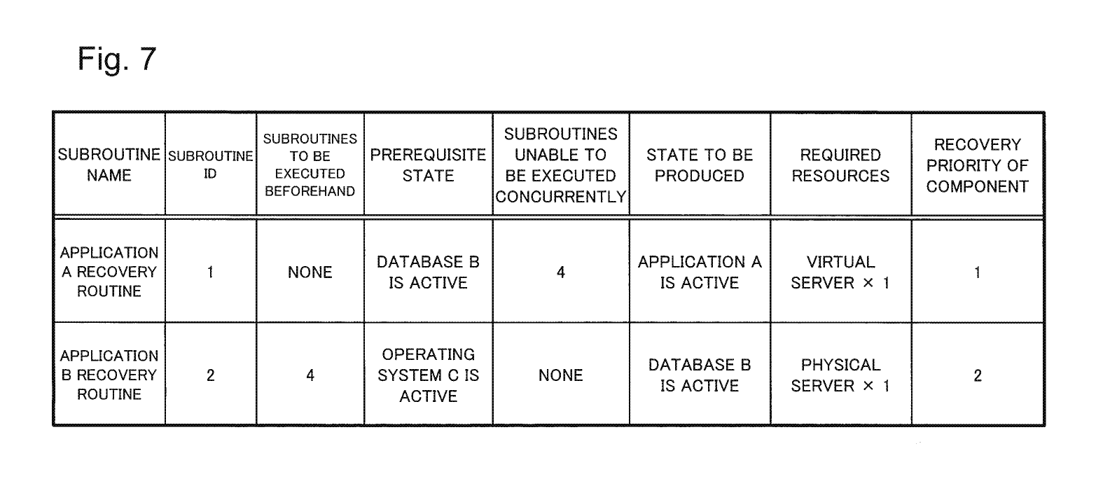

FIG. 7 is a diagram illustrating exemplary preconditions stored in a precondition storage unit 107 according to this exemplary embodiment. As illustrated in FIG. 7, the precondition storage unit 107 further stores required resources and the recovery priorities of components in addition to the items illustrated in FIG. 3.

The resource acceptance unit 112 accepts available resources among the resources included in the information system from an operator. For example, the operator inputs an available resource in the form “one physical server”, for example, and the resource acceptance unit 112 accepts the input.

The component-to-recover identifying unit 113 selects and identifies components to be recovered in an available range of resource in order of priority from among failed components. The selection is made on the basis of available resources accepted by the resource acceptance unit 112, the recovery priorities of components and required resources, that are stored in the precondition storage unit 107. The component-to-recover identifying unit 113 ends the selection when available resources run out.

A recovery subroutine identifying unit 103 identifies subroutines for recovering the components identified by the component-to-recover identifying unit 113.

Note that, in the fault recovery routine generating device 2 according to this exemplary embodiment, the components excluding the resource acceptance unit 112, the component-to-recover identifying unit 113, the precondition storage unit 107, and the recovery subroutine identifying unit 103 are the same as the corresponding components of the first exemplary embodiment and therefore the description of those components will be omitted.

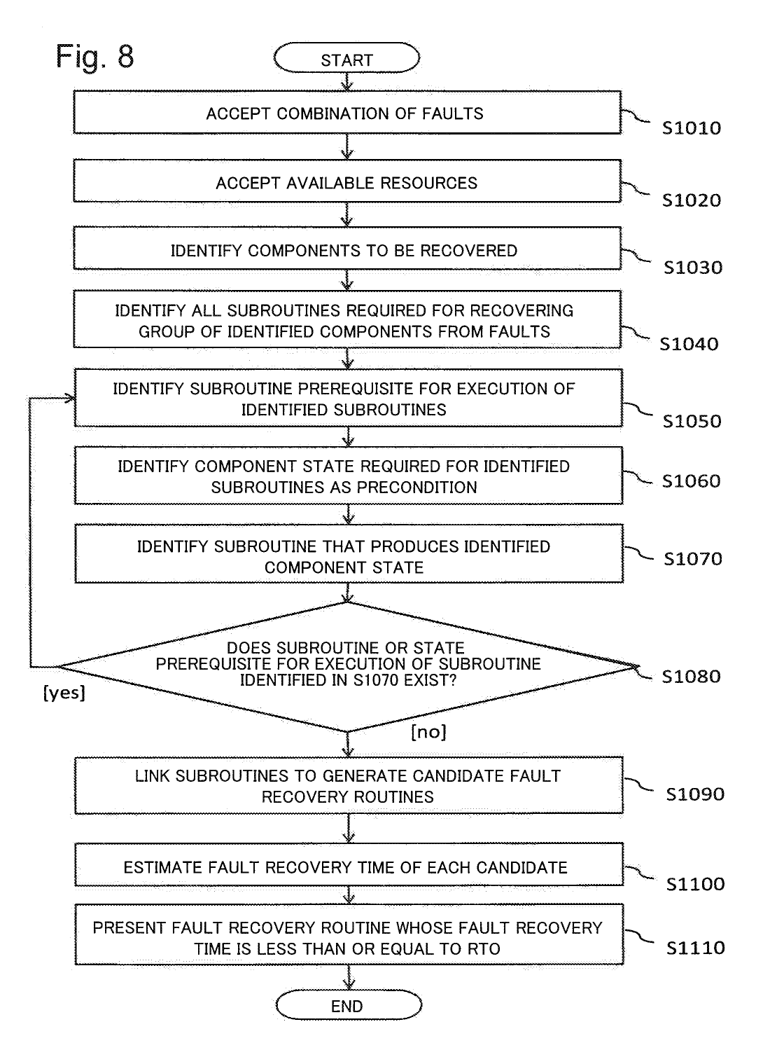

An operation of the fault recovery routine generating device 2 according to this exemplary embodiment will be described below. FIG. 8 is a flowchart illustrating an operation of the fault recovery routine generating device 2 according to this exemplary embodiment. Step S1010 and steps S1050-S1110 in FIG. 8 are the same as the corresponding steps of the operation of the first exemplary embodiment illustrated in FIG. 5 and therefore the description of the steps will be omitted.

After the processing at step S1010, the resource acceptance unit 112 accepts available resources from an operator (step S1020).

Then the component-to-recover identifying unit 113 identifies components to be recovered among the combination of components accepted at step S1010 on the basis of the available resources accepted at step S1020 and the recovery priorities of the components (step S1030).

The recovery subroutine identifying unit 103 identifies subroutines for recovering the component identified by the component-to-recover identifying unit 113 (step S1040).

The fault recovery routine generating device 2 according to this exemplary embodiment can achieve advantageous effects similar to the advantageous effects of the fault recovery routine generating device 1 according to the first exemplary embodiment.

The fault recovery routine generating device 2 according to this exemplary embodiment is further capable of automatically generating a fault recovery routine that can be executed in a situation where a reduced number of resources are available due to a disaster or the like by recovering high-priority components in the range of available resources.

### Exemplary Embodiment 3

A third exemplary embodiment (exemplary embodiment 3) of a fault recovery routine generating device according to the present invention will be described next. A user does not know beforehand how many operators can actually be sent to the location where an information system is installed in the event of a disaster. The user may have to recover the information system with limited human resources because operators themselves may have been struck by the disaster or personnel cannot be dispatched from other locations due to prohibition of traffic.

The fault recovery routine generating device 3 according to the third exemplary embodiment differs from the fault recovery routine generating device 1 according to the first exemplary embodiment in that the fault recovery routine generating device 3 generates a fault recovery routine in which the number of subroutines that are executed in parallel is less than or equal to the number of available operators. The following description will focus on the difference from the fault recovery routine generating device 1 according to the first exemplary embodiment.

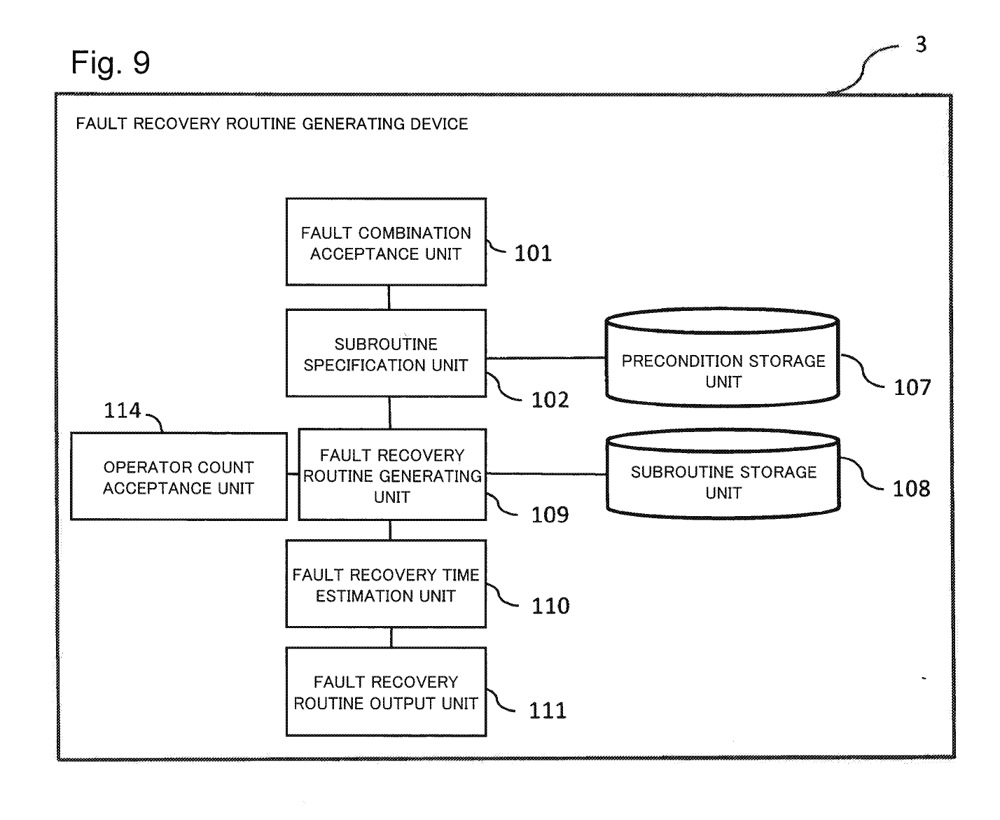

FIG. 9 is a block diagram illustrating a configuration of the fault recovery routine generating device 3 according to this exemplary embodiment. As illustrated in FIG. 9, the configuration of the fault recovery routine generating device 3 according to the third exemplary embodiment includes an operator count acceptance unit 114 in addition to the components of the fault recovery routine generating device 1 according to the first exemplary embodiment.

The operator count acceptance unit 114 accepts the number of available operators.

A fault recovery routine generating unit 109 generates candidate fault recovery routines under the further constraint that subroutines can be parallelized up to the number of available operators.

The components other than the operator count acceptance unit 114 and the fault recovery routine generating unit 109 are the same as the corresponding components of the first exemplary embodiment and therefore the description of those components will be omitted.

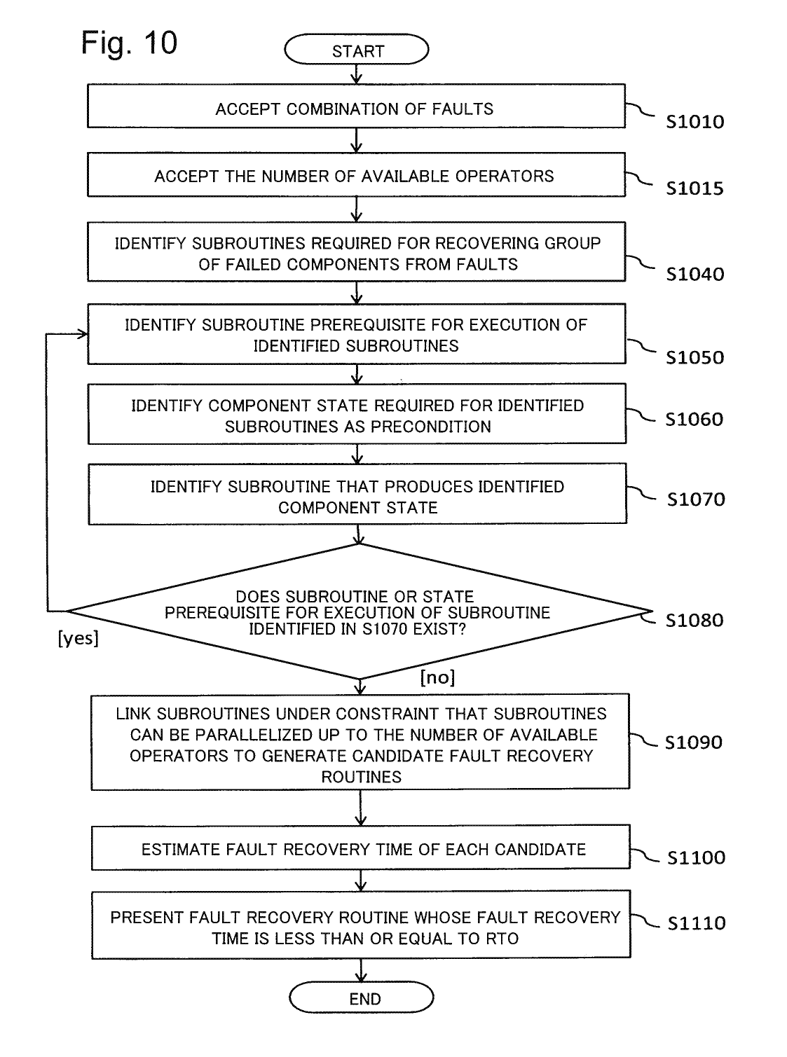

An operation of the fault recovery routine generating device 3 according to this exemplary embodiment will be described below. FIG. 10 is a flowchart illustrating an operation of the fault recovery routine generating device 3 according to this exemplary embodiment. As in the first exemplary embodiment, processing at step S1010 is performed first.

Then the operator count acceptance unit 114 accepts the number of available operators (step S1015). Then processing at step S1040 through step S1080 is performed as in the first exemplary embodiment.

Then the fault recovery routine generating unit 109 links subroutines among the subroutines identified at steps S1040, S1050 and S1070, under the further constraint that subroutines can be parallelized up to the number of available operators to generate a candidate fault recovery routine (step S1090). In other words, the fault recovery routine generating unit 109 generates a candidate fault recovery routine in which the number of subroutines that are executed in parallel is less than or equal to the number of available operators.

Then processing at steps S1100 and S1110 is performed as in the first exemplary embodiment.

The fault recovery routine generating device 3 according to this exemplary embodiment has advantageous effects similar to those of the first exemplary embodiment.

In addition, the fault recovery routine generating device 3 according to this exemplary embodiment generates a fault recovery routine in which the number of subroutines that are executed in parallel is less than or equal to the number of available operators. Thus the fault recovery routine generating device 3 can automatically generate a fault recovery routine that can be executed even when the number of available operators has changed.

Note that the present invention is not limited to the exemplary embodiments described above. Various modifications which are apparent to those skilled in the art can be made to the configurations and operations of the present invention within the scope of the present invention.

While the time required for executing each fault recovery routine is used as the evaluation index in the exemplary embodiments described above, other evaluation indexes, such as the cost, that relates to system requirements may be used.

The functions of the fault recovery routine generating devices 1 to 3 in the exemplary embodiments described above are implemented by a CPU executing a program (software). However, the fault recovery routine generating devices 1 to 3 may be implemented by hardware such as circuitry.

While the programs in the exemplary embodiments described above are stored in a storage device, the programs may be stored in a computer-readable recording medium. For example, the recording medium may be a portable medium such as a flexible disk, an optical disc, a magneto-optical disk, or a semiconductor memory.

Further, a fault recovery routine generating device according to the present invention may include the functions of the operator count acceptance unit 114 and the fault recovery routine generating unit 109 of the fault recovery routine generating device 3 of the third exemplary embodiment in addition to the functions of the fault recovery routine generating device 2 of the second exemplary embodiment.

As illustrated in FIG. 1, a fault recovery routine generating device according to the present invention includes as main components: a subroutine storage unit 108 which stores subroutines which are routines for recovering failed components; a precondition storage unit 107 which stores a precondition representing a condition required for executing the subroutines; a fault combination acceptance unit 101 which accepts a combination of faults that have occurred in components of an information system; a subroutine specification unit 102 which identifies subroutines required for recovering the components on the basis of the precondition and the combination of faults that have occurred in the components; a fault recovery routine generating unit 109 which acquires the identified subroutines from the subroutine storage unit 108 and links the identified subroutines to generate a candidate fault recovery routine which is a routine for recovering the information system; a fault recovery time estimation unit 110 which estimates the time required for fault recovery by the candidate fault recovery routine; and a fault recovery routine output unit 111 which outputs the candidate fault recovery routine whose fault recovery time is less than or equal to predetermined time as a fault recovery routine.

A fault recovery routine generating device described in (1) to (5) given below is also disclosed in the exemplary embodiments described above.

(1) A fault recovery routine generating device, wherein a precondition includes a prerequisite subroutine which is a subroutine that needs to be executed before execution of a subroutine (for example subroutines to be executed beforehand in FIGS. 3 and 7), and a subroutine specification unit (for example the subroutine specification unit 102) includes a recovery subroutine identifying unit (for example the recovery subroutine identifying unit 103) which identifies a subroutine for recovering the failed components, and a prerequisite subroutine identifying unit (for example the prerequisite subroutine identifying unit 104) which uses the prerequisite subroutine to identify a subroutine that needs to be executed before execution of the identified subroutines.
(2) The fault recovery routine generating device may be configured in such a manner that the precondition includes a prerequisite state which is a component state required for executing the subroutines (for example prerequisite states in FIGS. 3 and 7) and the subroutine specification unit includes a state identifying unit (for example the state identifying unit 105) which uses the prerequisite state to identify a component state required for executing the identified subroutines. The fault recovery routine generating device configured in this way allows a user to know component states required for executing identified subroutines and prerequisite subroutines.
(3) The fault recovery routine generating device may be configured in such a manner that the precondition includes a produced state which is a component state produced as a result of execution of each of the subroutines (for example state to be produced in FIGS. 3 and 7), and the subroutine specification unit includes a state producing subroutine identifying unit which uses the produced state to identify a subroutine required for producing the identified prerequisite state (for example the state producing subroutine identifying unit 106). The fault recovery routine generating device configured in this way can generate a fault recovery routine that recovers an entire information system including components that are required for executing subroutines and prerequisite subroutines even if the components have failed.
(4) The fault recovery routine generating device may be configured to include a resource acceptance unit (for example the resource acceptance unit 112) which accepts an available resource among resources included in the information system, and a component-to-recover identifying unit (for example the component-to-recover identifying unit 113) which identifies a component to be recovered from a combination of faults that have occurred in components on the basis of the available resource and predetermined priorities. The fault recovery routine generating device configured in this way can automatically generate a fault recovery routine that can be executed in a situation, such as a disaster, where available resources have decreased.
(5) The fault recovery routine generating device may be configured to include an operator count acceptance unit (for example the operator count acceptance unit 114) which accepts the number of available operators, wherein the fault recovery routine generating unit generates the candidate fault recovery routine in which a number of subroutines executed in parallel is less than or equal to the number of the operators. The fault recovery routine generating device configured in this way can automatically generate a fault recovery routine that can be executed even when the number of available operators has changed.

This application is based upon and claims the benefit of priority from Japanese Patent Application No. 2013-086208 filed on Apr. 17, 2013, the entire disclosure of which is incorporated herein.

While the present invention has been described with reference to exemplary embodiments, the present invention is not limited to the exemplary embodiments described above. Various modifications which are apparent to those skilled in the art can be made to the configurations and details of the present invention within the scope of the present invention.

### INDUSTRIAL APPLICABILITY

The present invention is applicable to devices and the like used for fault recovery for an information processing system.

### REFERENCE SIGNS LIST

1, 2, 3 Fault recovery routine generating device
101 Fault combination acceptance unit
102 Subroutine specification unit
103 Recovery subroutine identifying unit
104 Prerequisite subroutine identifying unit
105 State identifying unit
106 State producing subroutine identifying unit
107 Precondition storage unit
108 Subroutine storage unit
109 Fault recovery routine generating unit
110 Fault recovery time estimation unit
111 Fault recovery routine output unit
112 Resource acceptance unit
113 Component-to-recover identifying unit
114 Operator count acceptance unit

What is claimed is:

1.-8. (canceled)

9. A fault recovery routine generating device comprising circuitry configured to:
store subroutines which are routines for recovering failed components;
store a precondition representing a condition required for executing the subroutines;
accept a combination of faults that have occurred in components of an information system;
identify subroutines required for recovering the components on the basis of the precondition and the combination of faults that have occurred in the components;
acquire the identified subroutines from the stored subroutine and links the identified subroutines to generate a candidate fault recovery routine which is a routine for recovering the information system;
estimate the time required for fault recovery by the candidate fault recovery routine; and
output the candidate fault recovery routine whose fault recovery time is less than or equal to predetermined time as a fault recovery routine.

10. The fault recovery routine generating device according to claim 9, wherein the precondition comprises a prerequisite subroutine which is a subroutine that needs to be executed before execution of a subroutine, and
in the identifying subroutines, the circuitry is further configured to
identify a subroutine for recovering the failed components; and
use the prerequisite subroutine to identify a subroutine that needs to be executed before execution of the identified subroutines.

11. The fault recovery routine generating device according to claim 10,
wherein the precondition comprises a prerequisite state which is a component state required for executing the subroutines; and
in the identifying subroutines, the circuitry is configured to use the prerequisite state to identify a component state required for executing the identified subroutines.

12. The fault recovery routine generating device according to claim 11,
wherein the precondition comprises a produced state which is a component state produced as a result of execution of each of the subroutines; and
in the identifying subroutines, the circuitry is configured to use the produced state to identify a subroutine required for producing the identified component state.

13. The fault recovery routine generating device according to claim 9, the circuitry is further configured to:
accept an available resource among resources included in the information system; and
identify a component to be recovered from a combination of faults that have occurred in components on the basis of the available resource and predetermined priorities.

14. The fault recovery routine generating device according to claim 10, the circuitry is further configured to:
accept an available resource among resources included in the information system; and
identify a component to be recovered from a combination of faults that have occurred in components on the basis of the available resource and predetermined priorities.

15. The fault recovery routine generating device according to claim 11, the circuitry is further configured to:
accept an available resource among resources included in the information system; and
identify a component to be recovered from a combination of faults that have occurred in components on the basis of the available resource and predetermined priorities.

16. The fault recovery routine generating device according to claim 12, the circuitry is further configured to:
accept an available resource among resources included in the information system; and
identify a component to be recovered from a combination of faults that have occurred in components on the basis of the available resource and predetermined priorities.

17. The fault recovery routine generating device according claim 9, the circuitry is further configured to
accept the number of available operators,
in the generating a candidate fault recovery routine, generate the candidate fault recovery routine in which a number of subroutines executed in parallel is less than or equal to the number of the operators.

18. The fault recovery routine generating device according to claim 10, the circuitry further configured to
accept the number of available operators,
in the generating a candidate fault recovery routine, generate the candidate fault recovery routine in which a number of subroutines executed in parallel is less than or equal to the number of the operators.

19. The fault recovery routine generating device according to claim 11, the circuitry further configured to
accept the number of available operators,
in the generating a candidate fault recovery routine, generate the candidate fault recovery routine in which a number of subroutines executed in parallel is less than or equal to the number of the operators.

20. The fault recovery routine generating device according to claim 12, the circuitry further configured to
accept the number of available operators,
in the generating a candidate fault recovery routine, generate the candidate fault recovery routine in which a number of subroutines executed in parallel is less than or equal to the number of the operators.

21. The fault recovery routine generating device according to claim 13, the circuitry further configured to
accept the number of available operators,
in the generating a candidate fault recovery routine, generate the candidate fault recovery routine in which a number of subroutines executed in parallel is less than or equal to the number of the operators.

22. A fault recovery routine generating method comprises processing of:
storing subroutines which are routines for recovering components;
storing a precondition representing a condition required for executing the subroutines;
accepting a combination of faults that have occurred in components of an information system;
identifying subroutines required for recovering the components on the basis of the precondition and the combination of faults that have occurred in the components;
acquiring the identified subroutines from among the stored subroutines and linking the identified subroutines to generate a candidate fault recovery routine which is a routine for recovering the information system;
estimating the time required for fault recovery by the candidate fault recovery routine; and
outputting the candidate fault recovery routine whose fault recovery time is less than or equal to predetermined time as a fault recovery routine.

23. A non-transitory computer readable medium that stores therein a program causing a computer to execute processes of:
storing subroutines which are routines for recovering components;
storing a precondition representing a condition required for executing the subroutines;
accepting a combination of faults that have occurred in components of an information system;
identifying subroutines required for recovering the components on the basis of the precondition and the combination of faults that have occurred in the components;
acquiring the identified subroutines from among the stored subroutines and linking the identified subroutines to generate a candidate fault recovery routine which is a routine for recovering the information system;
estimating the time required for fault recovery by the candidate fault recovery routine; and
outputting the candidate fault recovery routine whose fault recovery time is less than or equal to predetermined time as a fault recovery routine.
